(19) United States
(12) Patent Application Publication
(10) Pub. No.: US 2025/0037060 A1
(43) Pub. Date: Jan. 30, 2025

(54) EFFICIENCY ANALYSIS METHOD FOR INTELLIGENT INTERACTION SYSTEM

(71) Applicant: China National Institute of Standardization, Beijing (CN)

(72) Inventors: Yunhong ZHANG, Beijing (CN); Yi YANG, Beijing (CN); Feng SI, Beijing (CN); Yuelin HU, Beijing (CN); Guoli LIU, Beijing (CN); Jun TAN, Beijing (CN)

(73) Assignee: China National Institute of Standardization, Beijing (CN)

(21) Appl. No.: 18/638,508

(22) Filed: Apr. 17, 2024

(30) Foreign Application Priority Data
Jul. 25, 2023 (CN) 202310912161.7

(51) Int. Cl. G06Q 10/0639; G06F 40/169

(52) U.S. Cl. CPC G06Q 10/0639; G06F 40/169

(57) ABSTRACT

Disclosed is an efficiency analysis method for an intelligent interaction system, including: obtaining user information and behavior data generated during execution of user commands, and associating the user information with the behavior data to obtain associated data; preprocessing the associated data, selecting efficiency indicators for the intelligent interaction system based on standard indicators, and classifying the preprocessed associated data according to the efficiency indicators to obtain classified data; formulating efficiency scoring criteria based on expert opinions, and obtaining efficiency scores of the classified data by using the efficiency scoring criteria; and determining weights of the efficiency scores by using an objective weight assignment method, and evaluating the efficiency scores through fuzzy comprehensive evaluation based on the weights to obtain comprehensive scores. The method not only improves the precision of efficiency analysis but also has good interpretability, making it directly applicable to efficiency analysis methods based on intelligent interaction systems.

### CROSS REFERENCE TO RELATED APPLICATION

This patent application claims the benefit and priority of Chinese Patent Application No. 2023109121617, filed with the China National Intellectual Property Administration on Jul. 25, 2023, the disclosure of which is incorporated by reference herein in its entirety as part of the present application.

### TECHNICAL FIELD

The present disclosure relates to the field of efficiency analysis, and in particular, to an efficiency analysis method for an intelligent interaction system.

### BACKGROUND

The application of efficiency analysis technology in the field of intelligent interactions is increasingly widespread, which can help managers of intelligent interaction systems to obtain efficiency analyses promptly and efficiently, thereby achieving precise adjustments of the intelligent interaction systems. Currently, intelligent interaction systems possess characteristics such as a vast amount of user information, diverse efficiency data, and high information density. Efficiency analysis methods for intelligent interaction systems have numerous uncertain factors, resulting in significant uncertainty within the efficiency analysis methods for intelligent interaction systems. Although some efficiency analysis methods for intelligent interaction systems have been invented, they still fail to effectively address the uncertainty issues within the efficiency analysis methods for intelligent interaction systems.

### SUMMARY

An objective of the present disclosure is to provide an efficiency analysis method for an intelligent interaction system.

In order to achieve the above objective, the present disclosure is implemented using the following technical solution:

The present disclosure includes the following steps:
A: obtaining user information and behavior data generated during execution of user commands, and associating the user information with the behavior data to obtain associated data;
B: preprocessing the associated data, selecting efficiency indicators for the intelligent interaction system based on standard indicators, and classifying the preprocessed associated data according to the efficiency indicators to obtain classified data, where the classifying includes inputting the preprocessed associated data into a random forest algorithm to obtain initial classified data and inputting the initial classified data into a naive Bayes algorithm to obtain the classified data;
C: formulating efficiency scoring criteria based on expert opinions, and obtaining efficiency scores of the classified data by using the efficiency scoring criteria; and
D: determining weights of the efficiency scores by using an objective weight assignment method, and evaluating the efficiency scores through fuzzy comprehensive evaluation based on the weights to obtain comprehensive scores.

Furthermore, the behavior data includes feedback results, response time, user satisfaction, error handling, task completion rate, user personalization, and interaction efficiency.

Furthermore, the preprocessing in step B includes cleaning the associated data by removing unnecessary punctuation, special characters, and tags, annotating and segmenting the cleaned associated data, and removing stop words.

Furthermore, said selecting the efficiency indicators for the intelligent interaction system based on the standard indicators includes consulting research papers, reports, and standards related to efficiency evaluation of the intelligent interaction system, obtaining existing efficiency evaluation indicators, analyzing the standard indicators, and screening the selected indicators based on characteristics, functions, and usage scenarios of the intelligent interaction system to obtain the efficiency indicators.

Furthermore, said inputting the preprocessed associated data into the random forest algorithm to obtain the initial classified data includes:
a: reading the preprocessed associated data and extracting features of the preprocessed associated data;
b. resampling the preprocessed associated data, generating a training subset through random extraction manner, using unextracted data as out-of-bag data, predicting the out-of-bag data using decision trees, disturbing feature values of the features, predicting feature importance measures of the decision trees, calculating a change in accuracy of collective random forest prediction, calculating weights of the decision trees, and obtaining importance measures of the features by weighted summation:

$${A}_{i} = {\sum }_{j} {ω}_{j} {D}_{ij} + {H}_{i}$$

where Aᵢ represents an importance measure of feature i, ωⱼ represents a weight of a j-th decision tree, Dᵢⱼ represents a feature importance measure of the feature i in the j-th tree, and Hᵢ represents a change in accuracy of random forest prediction for the feature i; and
c. sorting the feature importance measures of the associated data in descending order, selecting features through node splitting, constructing the decision trees using randomly selected features and the training subset, merging the out-of-bag data with feedback data of the associated data to form a test set, classifying the preprocessed associated data by using the decision trees based on votes, the feature importance measures, and the features, and classifying the test set.

Furthermore, said inputting the initial classified data into the naive Bayes algorithm includes:
inputting the initial classified data into the naive Bayes algorithm and calculating a conditional probability of feature occurrence in each category:

$$p ( \frac{{y}_{i}}{t} ) = \frac{p ( \frac{t}{{y}_{i}} ) p ( {y}_{i} )}{p ( t )}$$

where for the feature i and sample t, a probability of feature i in category y is p(yᵢ), a probability of sample t is p(t), and a probability of sample t in feature i of category y is

$$p ( \frac{t}{{y}_{i}} ) ;$$

and
calculating conditional probabilities in all classifications for each feature attribute, calculating a product of a category probability and a conditional probability for each category, and selecting a category with a maximum conditional probability as a classification category.

Furthermore, said determining the weights of the efficiency scores by using the objective weight assignment method includes:
normalizing the efficiency scores and calculating information carrying capacities of the normalized efficiency scores:

$${B}_{j} = \sqrt{\frac{{\sum }_{i = 1}^{n} ( {t}_{ij} - \overline{{t}_{j}} )}{n - 1}} {\sum }_{i = 1}^{n} ( 1 - {r}_{ij} )$$

where Bⱼ represents an information carrying capacity of a j-th efficiency score, there are n users, tᵢⱼ represents a j-th efficiency score of an i-th user, t̅ⱼ̅ represents an average value of the j-th efficiency score, and rᵢⱼ represents a correlation coefficient of the j-th efficiency score for the i-th user; and
calculating the weights of the efficiency scores:

$${c}_{j} = \frac{{B}_{j}}{{\sum }_{j = 1}^{m} {B}_{j}}$$

where there are m efficiency scores.

Furthermore, said evaluating the efficiency scores through fuzzy comprehensive evaluation based on the weights to obtain the comprehensive scores includes:
1) establishing an efficiency indicator set for comprehensive evaluation based on the efficiency indicators, and using a fuzzy matrix to express the weights of the efficiency scores determined using the objective weight assignment method;
2) establishing an efficiency score set for comprehensive evaluation based on the efficiency scores, quantifying each efficiency evaluation indicator, determining a membership degree of each efficiency evaluation indicator regarding the efficiency score set, and expressing the membership degrees using a fuzzy relation matrix; and
3) performing matrix operations using the fuzzy matrix and the fuzzy relation matrix to obtain a fuzzy comprehensive evaluation vector, which includes comprehensive scores for each efficiency evaluation indicator:

$$Q = E \times Z$$

where Q represents the fuzzy comprehensive evaluation vector, E represents the fuzzy matrix, and Z represents the fuzzy relation matrix.

The present disclosure has following beneficial effects:

The present disclosure provides an efficiency analysis method for an intelligent interaction system. Compared to the prior art, the present disclosure has the following technical effects:

1. Through preprocessing, data classification, and comprehensive scoring steps, the accuracy of efficiency analysis can be improved, enhancing the precision of efficiency analysis. The process is automated, which can significantly save labor and time costs, improve work efficiency, and achieve efficiency analysis for intelligent interaction systems. Real-time efficiency analysis for intelligent interaction systems is of great significance for efficiency analysis of intelligent interaction systems and can adapt to the efficiency analysis needs of different intelligent interaction systems and users, demonstrating a certain degree of universality.

2. The method of the present disclosure can comprehensively consider key indicators based on efficiency analysis of intelligent interaction systems, convert the efficiency analysis problem into a comprehensive evaluation problem through classification, and achieve precise control of efficiency analysis by classifying known preprocessed data. The method not only improves the precision of efficiency analysis but also has good interpretability, making it directly applicable to intelligent interaction systems.

### BRIEF DESCRIPTION OF THE DRAWINGS

FIG. 1 is a flowchart of steps of an efficiency analysis method for an intelligent interaction system according to the present disclosure.

### DETAILED DESCRIPTION OF THE EMBODIMENTS

The present disclosure is described in detail below with reference to the specific embodiments. Exemplary embodiments of the present disclosure are intended to explain the present disclosure herein, but are not intended to limit the present disclosure.

An efficiency analysis method for an intelligent interaction system of the present disclosure includes the following steps:

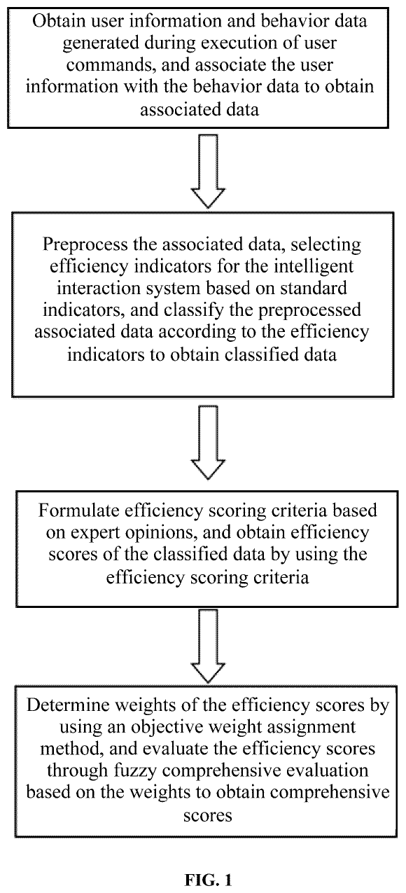

As shown in FIG. 1, in this embodiment, the method includes the following steps:

A: Obtain user information and behavior data generated during execution of user commands, and associate the user information with the behavior data to obtain associated data.

B: Preprocess the associated data, select efficiency indicators for the intelligent interaction system based on standard indicators, and classify the preprocessed associated data according to the efficiency indicators to obtain classified data, where the classifying includes inputting the preprocessed associated data into a random forest algorithm to obtain initial classified data and inputting the initial classified data into a naive Bayes algorithm to obtain the classified data.

C: Formulate efficiency scoring criteria based on expert opinions, and obtain efficiency scores of the classified data by using the efficiency scoring criteria.

D: Determine weights of the efficiency scores by using an objective weight assignment method, and evaluate the efficiency scores through fuzzy comprehensive evaluation based on the weights to obtain comprehensive scores.

In this embodiment, the behavior data includes feedback results, response time, user satisfaction, error handling, task completion rate, user personalization, and interaction efficiency.

In this embodiment, the preprocessing in step B includes cleaning the associated data by removing unnecessary punctuation, special characters, and tags, annotating and segmenting the cleaned associated data, and removing stop words.

In actual evaluation, a specific voice assistant is used as the research subject, and voice commands from the user are “What is the weather like tomorrow afternoon?” and “Wake me up at 7 AM tomorrow morning.” Voice commands after preprocessing are “tomorrow/afternoon/weather” and “tomorrow/morning/7 AM/wake up,” with a response time of 800 ms, user satisfaction of 80, an error rate of 3, a task completion rate of 100%, user personalization of 42%, and interaction efficiency of 70%. Feedback results include “rain” and “I have set an alarm for you tomorrow at 7 AM,” and feedback results after preprocessing are “rain” and “set/tomorrow/7 AM/alarm.”

In this embodiment, said selecting the efficiency indicators for the intelligent interaction system based on the standard indicators includes consulting research papers, reports, and standards related to efficiency evaluation of the intelligent interaction system, obtaining existing efficiency evaluation indicators, analyzing the standard indicators, and screening the selected indicators based on characteristics, functions, and usage scenarios of the intelligent interaction system to obtain the efficiency indicators.

In actual evaluation, the existing standard indicators include response time, user satisfaction, task completion rate, interaction efficiency, error rate, error recovery efficiency, and task load. Efficiency indicators selected based on the characteristics of the voice assistant are response time, user satisfaction, task completion rate, and error rate.

In this embodiment, said inputting the preprocessed associated data into the random forest algorithm to obtain the initial classified data includes:
a: reading the preprocessed associated data and extracting features of the preprocessed associated data;
b. resampling the preprocessed associated data, generating a training subset through random extraction manner, using unextracted data as out-of-bag data, predicting the out-of-bag data using decision trees, disturbing feature values of the features, predicting feature importance measures of the decision trees, calculating a change in accuracy of collective random forest prediction, calculating weights of the decision trees, and obtaining importance measures of the features by weighted summation:

$${A}_{i} = {\sum }_{j} {ω}_{j} {D}_{ij} + {H}_{i}$$

where Aᵢ represents an importance measure of feature i, ωⱼ represents a weight of a j-th decision tree, Dᵢⱼ represents a feature importance measure of the feature i in the j-th tree, and Hᵢ represents a change in accuracy of random forest prediction for the feature i; and
c. sorting the feature importance measures of the associated data in descending order, selecting features through node splitting, constructing the decision trees using randomly selected features and the training subset, merging the out-of-bag data with feedback data of the associated data to form a test set, classifying the preprocessed associated data by using the decision trees based on votes, the feature importance measures, and the features, and classifying the test set.

In actual evaluation, the features of “tomorrow/afternoon/weather” are tomorrow, afternoon, and weather. The features of “tomorrow/morning/7 AM/wake up” are tomorrow, morning, 7 AM. The feature of “rain” is rain. The features of “set/tomorrow/7 AM/alarm” are tomorrow, 7 AM, alarm. The initial classified data is alarm setting and weather conditions.

In this embodiment, said inputting the initial classified data into the naive Bayes algorithm includes:
inputting the initial classified data into the naive Bayes algorithm and calculating a conditional probability of feature occurrence in each category:

$$p ( \frac{{y}_{i}}{t} ) = \frac{p ( \frac{t}{{y}_{i}} ) p ( {y}_{i} )}{p ( t )}$$

where for the feature i and sample t, a probability of feature i in category y is p(yᵢ), a (t) probability of sample t is p(t), and a probability of sample t in feature i of category y is

$$p ( \frac{t}{{y}_{i}} ) ;$$

and
calculating conditional probabilities in all classifications for each feature attribute, calculating a product of a category probability and a conditional probability for each category, and selecting a category with a maximum conditional probability as a classification category.

In actual evaluation, the classification result is alarm and weather.

In this embodiment, said determining the weights of the efficiency scores by using the objective weight assignment method includes:

normalizing the efficiency scores and calculating information carrying capacities of the normalized efficiency scores:

$${B}_{j} = \sqrt{\frac{{\sum }_{i = 1}^{n} ( {t}_{ij} - \overline{{t}_{j}} )}{n - 1}} {\sum }_{i = 1}^{n} ( 1 - {r}_{ij} )$$

where Bⱼ represents an information carrying capacity of a j-th efficiency score, there are n users, tᵢⱼ represents a j-th efficiency score of an i-th user, t̅ⱼ̅ represents an average value of the j-th efficiency score, and rᵢⱼ represents a correlation coefficient of the j-th efficiency score for the i-th user; and
calculating the weights of the efficiency scores:

$${c}_{j} = \frac{{B}_{j}}{{\sum }_{j = 1}^{m} {B}_{j}}$$

where there are m efficiency scores.

In actual evaluation, the normalized efficiency scores are 0.6 for the response time, 0.8 for the user satisfaction, 1 for the task completion rate, and 0.3 for the error rate. The weights of the efficiency indicators, i.e., the response time, user satisfaction, task completion rate, and error rate, are 0.23, 0.347, 0.209, and 0.214, respectively.

In this embodiment, said evaluating the efficiency scores through fuzzy comprehensive evaluation based on the weights to obtain the comprehensive scores includes:
1) establishing an efficiency indicator set for comprehensive evaluation based on the efficiency indicators, and using a fuzzy matrix to express the weights of the efficiency scores determined using the objective weight assignment method;
2) establishing an efficiency score set for comprehensive evaluation based on the efficiency scores, quantifying each efficiency evaluation indicator, determining a membership degree of each efficiency evaluation indicator regarding the efficiency score set, and expressing the membership degrees using a fuzzy relation matrix; and
3) performing matrix operations using the fuzzy matrix and the fuzzy relation matrix to obtain a fuzzy comprehensive evaluation vector, which includes comprehensive scores for each efficiency evaluation indicator:

$$Q = E \times Z$$

where Q represents the fuzzy comprehensive evaluation vector, E represents the fuzzy matrix, and Z represents the fuzzy relation matrix.

In actual evaluation, the comprehensive scores for the efficiency indicators, i.e., the response time, user satisfaction, task completion rate, and error rate, are 0.0138, 0.2776, 0.209, and 0.0642, respectively. Based on these comprehensive scores, the accuracy of data analysis of the intelligent interaction system is adjusted, and the voice recognition performance and text analysis capability of the system are enhanced.

The above are merely preferred examples of the present disclosure, and are not intended to limit the present disclosure. Any modifications, equivalent replacements, improvements, and the like made within the spirit and principle of the present disclosure shall be all included in the protection scope of the present disclosure.

What is claimed is:

1. An efficiency analysis method for an intelligent interaction system, comprising the following steps:
A: obtaining user information and behavior data generated during execution of user commands, and associating the user information with the behavior data to obtain associated data;
B: preprocessing the associated data, selecting efficiency indicators for the intelligent interaction system based on standard indicators, and classifying the preprocessed associated data according to the efficiency indicators to obtain classified data, wherein the classifying comprises inputting the preprocessed associated data into a random forest algorithm to obtain initial classified data and inputting the initial classified data into a naive Bayes algorithm to obtain the classified data;
C: formulating efficiency scoring criteria based on expert opinions, and obtaining efficiency scores of the classified data by using the efficiency scoring criteria; and
D: determining weights of the efficiency scores by using an objective weight assignment method, and evaluating the efficiency scores through fuzzy comprehensive evaluation based on the weights to obtain comprehensive scores.

2. The efficiency analysis method for an intelligent interaction system according to claim 1, wherein the behavior data comprises feedback results, response time, user satisfaction, error handling, task completion rate, user personalization, and interaction efficiency.

3. The efficiency analysis method for an intelligent interaction system according to claim 1, wherein the preprocessing in step B comprises cleaning the associated data by removing unnecessary punctuation, special characters, and tags, annotating and segmenting the cleaned associated data, and removing stop words.

4. The efficiency analysis method for an intelligent interaction system according to claim 1, wherein said inputting the preprocessed associated data into the random forest algorithm to obtain the initial classified data comprises:
a: reading the preprocessed associated data and extracting features of the preprocessed associated data;
b. resampling the preprocessed associated data, generating a training subset through random extraction manner, using unextracted data as out-of-bag data, predicting the out-of-bag data using decision trees, disturbing feature values of the features, predicting feature importance measures of the decision trees, calculating a change in accuracy of collective random forest prediction, calculating weights of the decision trees, and obtaining importance measures of the features by weighted summation:
$${A}_{i} = {\sum }_{i} {ω}_{i} {D}_{ij} + {H}_{i}$$
wherein Aᵢ represents an importance measure of feature i, ωⱼ represents a weight of a j-th decision tree, Dᵢⱼ represents a feature importance measure of the feature i in the j-th tree, and Hᵢ represents a change in accuracy of random forest prediction for the feature i; and
c. sorting the feature importance measures of the associated data in descending order, selecting features through node splitting, constructing the decision trees using randomly selected features and the training subset, merging the out-of-bag data with feedback data of the associated data to form a test set, classifying the preprocessed associated data by using the decision trees based on votes, the feature importance measures, and the features, and classifying the test set.

5. The efficiency analysis method for an intelligent interaction system according to claim 1, wherein said inputting the initial classified data into the naive Bayes algorithm to obtain the classified data comprises:
inputting the initial classified data into the naive Bayes algorithm and calculating a conditional probability of feature occurrence in each category:
$$p ( \frac{{y}_{i}}{t} ) = \frac{p ( \frac{t}{{y}_{i}} ) p ( {y}_{i} )}{p ( t )}$$
wherein for the feature i and sample t, a probability of the feature i in category y is p(yᵢ), a probability of the sample t is p(t), and a probability of the sample t in the feature i of the category y is
$$p ( \frac{t}{{y}_{i}} ) ;$$
and
calculating conditional probabilities in all classifications for each feature attribute, calculating a product of a category probability and a conditional probability for each category, and selecting a category with a maximum conditional probability as a classification category.

6. The efficiency analysis method for an intelligent interaction system according to claim 1, wherein said determining the weights of the efficiency scores by using the objective weight assignment method comprises:
normalizing the efficiency scores and calculating information carrying capacities of the normalized efficiency scores:
$${B}_{j} = \sqrt{\frac{{\sum }_{i = 1}^{n} ( {t}_{ij} - \overline{{t}_{j}} )}{n - 1}} {\sum }_{i = 1}^{n} ( 1 - {r}_{ij} )$$
wherein Bⱼ represents an information carrying capacity of a j-th efficiency score, there are n users, tᵢⱼ represents a j-th efficiency score of an i-th user, t̅ⱼ̅ represents an average value of the j-th efficiency score, and rᵢⱼ represents a correlation coefficient of the j-th efficiency score for the i-th user; and
calculating the weights of the efficiency scores:
$${c}_{j} = \frac{{B}_{j}}{{\sum }_{j = 1}^{m} {B}_{j}}$$
wherein there are m efficiency scores.

7. The efficiency analysis method for an intelligent interaction system according to claim 1, wherein said evaluating the efficiency scores through fuzzy comprehensive evaluation based on the weights to obtain the comprehensive scores comprises:
1) establishing an efficiency indicator set for comprehensive evaluation based on the efficiency indicators, and using a fuzzy matrix to express the weights of the efficiency scores determined using the objective weight assignment method;
2) establishing an efficiency score set for comprehensive evaluation based on the efficiency scores, quantifying each efficiency evaluation indicator, determining a membership degree of each efficiency evaluation indicator regarding the efficiency score set, and expressing the membership degrees using a fuzzy relation matrix; and
3) performing matrix operations using the fuzzy matrix and the fuzzy relation matrix to obtain a fuzzy comprehensive evaluation vector, which comprises comprehensive scores for each efficiency evaluation indicator:
$$Q = E \times Z$$
wherein Q represents the fuzzy comprehensive evaluation vector, E represents the fuzzy matrix, and Z represents the fuzzy relation matrix.
